(19) United States
(12) Patent Application Publication
(10) Pub. No.: US 2005/0246893 A1
(43) Pub. Date: Nov. 10, 2005

(54) Turbine rotor repair method

(76) Inventors: Yoshiaki Fukunaga, Hyogo (JP); Takashi Shige, Hyogo (JP); Masahiko Yamashita, Hyogo (JP); Hidenori Kanki, Hyogo (JP)

Correspondence Address: BIRCH STEWART KOLASCH & BIRCH, PO BOX 747, FALLS CHURCH, VA, 22040-0747, US

(21) Appl. No.: 10/520,062

(22) PCT Filed: Nov. 25, 2003
(86) PCT No.: PCT/JP03/15045

§ 371 Date: Jan. 5, 2005

(30) Foreign Application Priority Data
Dec. 2, 2002 (JP) 2002-350262

(51) Int. Cl. B23P 6/00

(52) U.S. Cl. 29/889.1; 29/402.13; 29/402.16

(57) ABSTRACT

A turbine rotor repair method capable of forming a repair part by applying a deposit welding to a rotor material, the deposit welding being a thin deposit welding with a high deposition rate, wherein the repair part is formed by stacking beads by the thin deposit welding, and the thin deposit welding with the high deposition rate is performed by a submerged arc welding using a conductive flux.

### TECHNICAL FIELD

The present invention relates to a method of repairing a blade groove on a turbine rotor.

### BACKGROUND ART

A rotor for a steam turbine, for example, has blade grooves formed in a peripheral portion thereof to permit turbine blades to be fitted thereon. As is conventionally well known, as such a rotor is used for a long period, stress corrosion cracks may develop in the blade grooves thereof. When this happens, one method of repairing such a crack is first removing the blade groove in which the crack has developed and then restoring the blade groove by build-up welding. FIG. 10 is a vertical cross-sectional view schematically showing how a rotor is repaired by this conventional method. In this figure, reference numeral 1 represents the rotor body, and reference numeral 2 represents the repaired portion thereof. Here, on the rotor body 1 having the blade groove removed therefrom, build-up welding is performed in layers so as to thereby form the repaired portion 2. Thereafter, a groove is formed in this repaired portion 2 so as to thereby restore an unillustrated blade groove.

However, the low-alloy steel used to form a steam turbine rotor contains vanadium, and tends to develop coarse crystal grain during the post-welding heat treatment to which it is subjected after welding. Such a portion (indicated by “a” in the figure) affected by welding heat tends to develop reheating cracks. One practical indicator of the likeliness of such reheating cracks developing in a given material is given by the following formula on the basis of the ingredients of the material:
ΔG=3.3 Mo %+Cr %+8.1 V %−2
ΔG≧0

Here, Mo represents molybdenum, Cr represents chromium, and V represents vanadium. Moreover, it is assumed that the chromium content is about 2.5% or less. A material that fulfills the above formula tends to develop reheating cracks.

Incidentally, the types of rotor base material that are typically used nowadays have the following ΔG values:

| | |
|---|---|
| 1CrMoV steel: | ΔG ≈ 9.6 |
| 2CrMoV steel: | ΔG ≈ 5.8 |
| 3.5NiCrMoV steel: | ΔG ≈ 2.1 |

That is, all these materials tend to develop reheating cracks.

To prevent reheating cracks, build-up welding needs to be performed so as not to develop coarse crystal grain in a welding-heat-affected portion. One way to achieve this is to adopt a welding method with a low deposition rate, such as TIG (tungsten-inert-gas) welding, and to perform so-called thin-layer build-up welding. This permits a welding-heat-affected portion to be subjected repeatedly to a welding heat cycle and thus come to have a fine-grained structure, making it possible to prevent reheating cracks.

However, simply adopting a welding method with a low deposition rate, such as TIG welding, as described above is uneconomical because it takes more time and cost. On the other hand, submerge arc welding is known as a welding method with a high deposition rate. This welding method, however, generates a high welding heat input, and thus produces a deep penetration shape in a welded portion, preventing a welding heat cycle from reaching sufficiently around. Accordingly, this welding method tends to cause coarse crystal grain in a welding-heat-affected portion, and thus reheating cracks.

### DISCLOSURE OF THE INVENTION

An object of the present invention is to provide a method of repairing a turbine rotor that prevents reheating cracks in a welding-heat-affected portion and that permits highly efficient welding.

To achieve the above object, according to the present invention, in a method of repairing a turbine rotor by performing build-up welding on a rotor material so as to form a repaired portion thereon, the build-up welding is achieved by performing thin-layer build-up welding at a high deposition rate whereby the repaired portion is formed as a result of beads for thin-layer build-up welding being laid in layers.

Advisably, in the above method of repairing a turbine rotor, the thin-layer build-up welding at a high deposition rate is achieved by performing arc welding using an electrically conductive flux.

Advisably, in the above method of repairing a turbine rotor, the repaired portion is formed by first performing build-up welding at a comparatively low deposition rate from the first layer of said repaired portion up to a predetermined height and then performing build-up welding at a comparatively high deposition rate for the remaining portion of the repaired portion.

Advisably, in the above method of repairing a turbine rotor, a groove is formed in the repaired portion in order to restore a rotor blade groove.

### BRIEF DESCRIPTION OF DRAWINGS

FIG. 1 is a vertical cross-sectional view schematically showing how a rotor is repaired by the repairing method of a first embodiment of the invention.

FIG. 2 is a vertical cross-sectional view schematically showing how a rotor is repaired by the repairing method of a second embodiment of the invention.

FIG. 3 is a vertical cross-sectional view schematically showing how a rotor is repaired by the repairing method of a third embodiment of the invention.

FIG. 4 is a vertical cross-sectional view schematically showing how a rotor is repaired by the repairing method of a fourth embodiment of the invention.

FIG. 5 is a vertical cross-sectional view schematically showing the condition before repair around a blade groove formed in a peripheral portion of an example of a rotor.

FIG. 6 is a diagram schematically showing the condition before repair around a blade groove formed in a peripheral portion of another example of a rotor, as seen along the rotor axis.

FIG. 7 is a vertical cross-sectional view schematically showing how welding beads are laid in layers when a rotor is repaired.

FIG. 8 is a diagram schematically showing the rotor body in the middle of being subjected to build-up welding, as seen from outside.

FIG. 9 is a horizontal cross-sectional view schematically showing the position at which welding is performed when a rotor is repaired.

FIG. 10 is a vertical cross-sectional view schematically showing how a rotor is repaired by a conventional method.

### BEST MODE FOR CARRYING OUT THE INVENTION

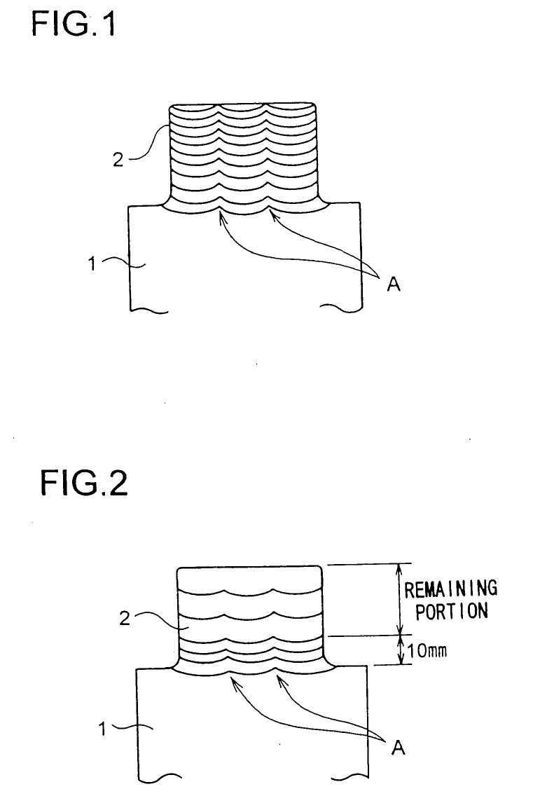

Hereinafter, embodiments of the present invention will be described with reference to the drawings. In the figures referred to in the following descriptions, such parts as serve the same purposes among different figures are identified with the same reference numerals and symbols. FIG. 1 is a vertical cross-sectional view schematically showing how a rotor is repaired by the repairing method of a first embodiment of the invention. To obtain a perfectly fine-grained structure in a welding-heat-affected portion as described earlier, it is essential that build-up welding be performed by the use of welding beads that produce shallow penetration. Moreover, according to the present invention, to perform welding at a high deposition rate, submerge arc welding is adopted.

It is usually difficult to perform submerge arc welding with shallow penetration. However, using an electrically conductive flux helps widen the arc obtained during welding, and thus makes it possible to perform welding with greater width and shallower penetration. Suitably used as an electrically conductive flux is, for example, the PFH-203 flux manufactured by Kobe Steel, Ltd.

It is also essential that welding be performed under controlled conditions. Specifically, performing welding under the following conditions makes it possible to obtain a perfectly fine-grained structure in a welding-heat-affected portion:

| | |
|---|---|
| Welding Current: | 400 ± 20 A |
| Welding Voltage: | 32 ± 3 V |
| Welding Rate: | 310 ± 20 mm/min |
| Welding Wire Diameter: | φ 4 mm |

Under these welding conditions, welding proceeds at a deposition rate of about 180 g/min. This is about 20 times the ordinary rate as compared with TIG welding and the like, and thus offers welding efficiency sufficient for build-up welding performed on a rotor. When a rotor material mentioned earlier is subjected to build-up welding under these conditions and then to post-welding heat treatment, no reheating cracks develop. Thus, the entire welding-heat-affected portion indicated by “A” in FIG. 1 comes to have a fine-grained structure as it undergoes the succeeding welding heat cycles. That is, no coarsening of the crystal grain occurs.

FIG. 2 is a vertical cross-sectional view schematically showing how a rotor is repaired by the repairing method of a second embodiment of the invention. In this embodiment, first, build-up welding is performed in the same manner as in the first embodiment described above from the first layer up to a predetermined height, and thereafter build-up welding is performed by a welding method with a higher deposition rate for the remaining portion. This makes it possible not only to give the welding-heat-affected portion “A” a fine-grained structure but also to perform welding at a higher rate.

Specifically, first, build-up welding just as performed in the first embodiment (submerge arc welding using a welding wire with a diameter of φ4 mm) is performed from the first layer up to a height of 10 mm or more, and thereafter build-up welding is performed by submerge arc welding using a welding wire with a diameter of φ5 mm for the remaining portion. Here, the height of 10 mm or more is such that the heat-affected zone ascribable to submerge arc welding using a welding wire with a diameter of φ5 mm does not reach the welding-heat-affected portion “A.” The welding conditions other than the welding wire diameter are the same. Incidentally, here, the welding using a welding wire with a diameter of φ5 mm proceeds at a deposition rate of about 230 g/min.

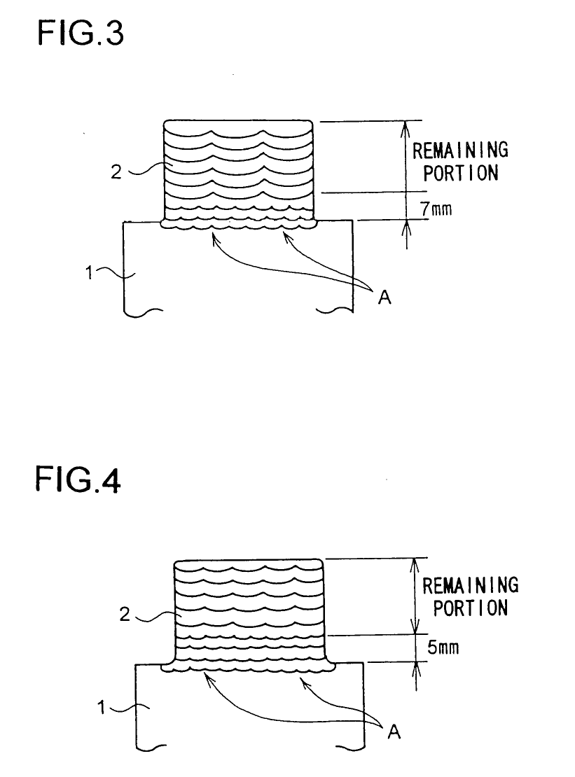

FIG. 3 is a vertical cross-sectional view schematically showing how a rotor is repaired by the repairing method of a third embodiment of the invention. In this embodiment, first, build-up welding is performed by so-called TIG welding, which generates a low welding heat input, from the first layer up to a predetermined height, and thereafter build-up welding is performed in the same manner as in the first embodiment described above for the remaining portion. This makes it possible not only to give the welding-heat-affected portion “A” a perfectly fine-grained structure but also to perform welding at a higher rate.

Specifically, first, build-up welding by TIG welding is performed from the first layer up to a height of 7 mm or more, and thereafter build-up welding is performed in the same manner as in the first embodiment for the remaining portion. Here, the height of 7 mm or more is such that the heat-affected zone ascribable to submerge arc welding as performed in the first embodiment does not reach the welding-heat-affected portion “A.” Incidentally, here, the TIG welding proceeds at a deposition rate of about 10 g/min.

FIG. 4 is a vertical cross-sectional view schematically showing how a rotor is repaired by the repairing method of a fourth embodiment of the invention. In this embodiment, first, build-up welding is performed by TIG welding from the first layer up to a predetermined height, and thereafter build-up welding is performed by so-called hot TIG welding, whereby welding is performed with a heating current passed through the welding wire, for the remaining portion. This makes it possible not only to give the welding-heat-affected portion “A” a perfectly fine-grained structure but also to perform welding at a higher rate.

Specifically, first, build-up welding by TIG welding is performed from the first layer up to a height of 5 mm or more, and thereafter build-up welding is performed by hot TIG welding for the remaining portion. Here, the height of 5 mm or more is such that the heat-affected zone ascribable to hot TIG welding does not reach the welding-heat-affected portion “A.” Incidentally, here, the TIG welding proceeds at a deposition rate of about 10 g/min, and the hot TIG welding proceeds at a deposition rate of about 40 g/min. An example of the conditions under which the TIG and hot TIG welding here is performed is shown below.

The TIG welding is performed, for example, under the following conditions:

| | |
|---|---|
| Welding Current: | 280 A |
| Welding Voltage: | 12 V |
| Welding Rate: | 100 mm/min |
| Welding Wire Diameter: | φ 1.6 mm |
| Wire Feed Rate: | 10 g/min |

The hot TIG welding is performed, for example, under the following conditions:

| | |
|---|---|
| Welding Current: | 280 A |
| Welding Voltage: | 12 V |
| Welding Rate: | 100 mm/min |
| Welding Wire Diameter: | φ 1.6 mm |
| Wire Heating Current: | 150 A |
| Wire Feed Rate: | 40 g/min |

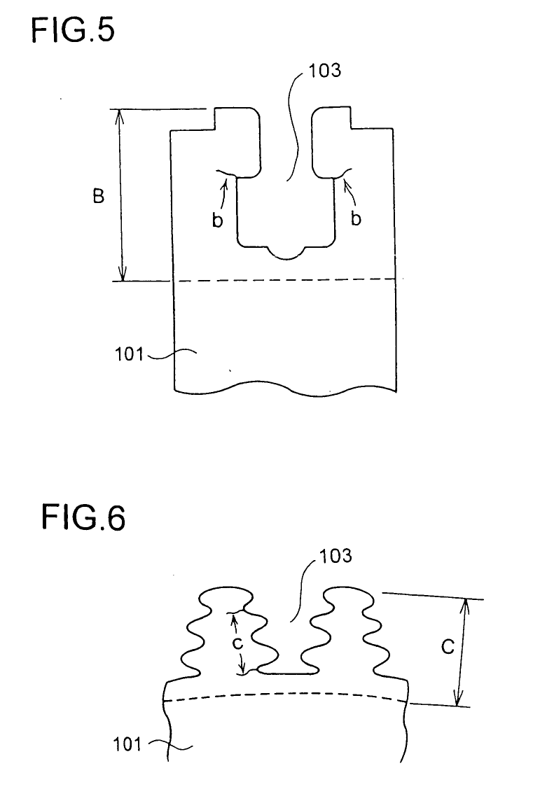

Now, an overall review will be given of the procedure for repairing a blade groove on a turbine rotor to which the present invention is applicable. FIG. 5 is a vertical cross-sectional view schematically showing the condition before repair around a blade groove formed in a peripheral portion of an example of a rotor. This figure shows the type of blade groove that is formed perpendicularly to the rotor axis. Suppose that, as shown in the figure, cracks “b” have developed, for example, at corners of a blade groove 103 formed in a peripheral portion of a rotor body 101. In this case, first, the entire peripheral portion of the rotor body 101, i.e., the portion indicated as the to-be-repaired portion “B,” is removed.

On the other hand, FIG. 6 is a diagram schematically showing the condition before repair around a blade groove formed in a peripheral portion of another example of a rotor, as seen along the rotor axis. This figure shows the type of blade groove that is formed along the rotor axis. Suppose that, as shown in the figure, cracks “c” have developed, for example, at troughs of a blade groove 103 formed in a peripheral portion of a rotor body 101. In this case also, first, the entire peripheral portion of the rotor body 101, i.e., the portion indicated as the to-be-repaired portion “C,” is removed.

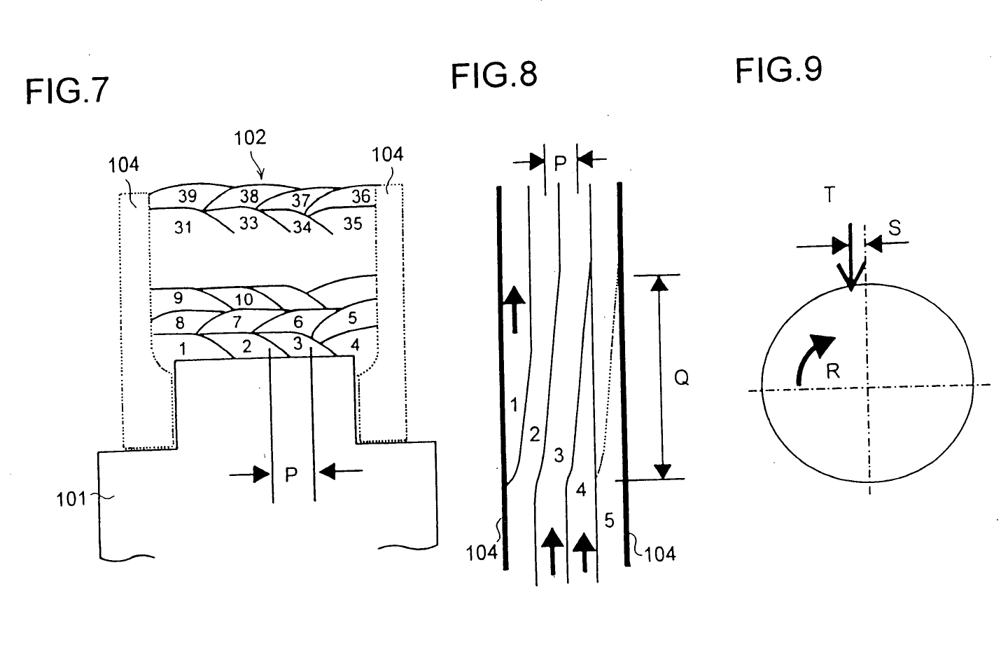

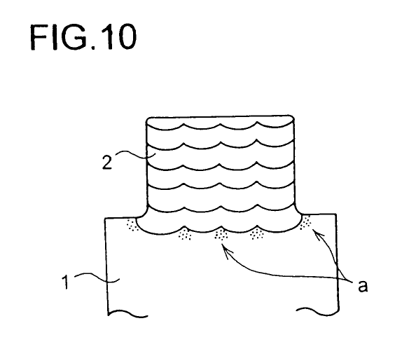

FIG. 7 is a vertical cross-sectional view schematically showing how welding beads are laid in layers when a rotor is repaired. Here, after the entire peripheral portion of the rotor body is removed as the to-be-repaired portion as shown in FIG. 5 or 6, for example, water-cooled ring-shaped copper walls 104 are so fitted as to sandwich a zone in the vicinity of the peripheral portion of the rotor body 101 from in front and behind. Then, while the rotor body 101 is being rotated, build-up welding is performed between the copper walls 104. Here, welding beads are laid in layers in increasing order of their numbers indicated in the figure while the welding position is shifted by a predetermine welding pitch “P” every turn of the rotor body 101 until eventually a repaired portion 102 is formed. The figure shows a case where welding is performed in 39 layers.

FIG. 8 is a diagram schematically showing the rotor body in the middle of being subjected to build-up welding, as seen from outside, and shows how the welding beads are laid in shifted positions. As shown in this figure, build-up welding is performed between the copper walls 104 while the rotor body 101 is being rotated, while each welding bead is run in the welding direction indicated by arrows, and while the welding position is shifted by the predetermined welding pitch “P” every turn so that the welding beads are laid in layers in increasing order of their numbers. An overlap “Q” is secured between every two consecutive turns.

FIG. 9 is a horizontal cross-sectional view schematically showing the position at which welding is performed when a rotor is repaired. As shown in this figure, the welding position is located at the position indicated by arrow “T” where the welding beads land on the periphery of the rotor body 101, which is rotating in the direction indicated by arrow “R,” with a predetermined eccentric distance “S” on the “ascending” side (i.e., on the left of the middle of the figure). This makes it possible to perform build-up welding with the welding beads spread into thin, wide layers. If the welding position is located at the position where the welding beads land on the periphery of the rotor body on the “descending” side (i.e., on the right of the middle of the figure), build-up welding is performed with the welding beads formed into narrow, thick lumps.

Obviously, many modifications and variations of the present invention are possible in light of the above teachings. It is therefore to be understood that within the scope of the appended claims, the invention may be practiced other than as specifically described.

### INDUSTRIAL APPLICABILITY

As described above, according to the present invention, it is possible to provide a method of repairing a turbine rotor that prevents reheating cracks in a welding-heat-affected portion and that permits highly efficient welding.

1. A method of repairing a turbine rotor by performing build-up welding on a rotor material so as to form a repaired portion thereon,
wherein said build-up welding is achieved by performing thin-layer build-up welding at a high deposition rate whereby said repaired portion is formed as a result of beads for thin-layer build-up welding being laid in layers.

2. A method of repairing a turbine rotor as claimed in claim 1,
wherein said thin-layer build-up welding at a high deposition rate is achieved by performing arc welding using an electrically conductive flux.

3. A method of repairing a turbine rotor as claimed in claim 1,
wherein said repaired portion is formed by first performing build-up welding at a comparatively low deposition rate from a first layer of said repaired portion up to a predetermined height and then performing build-up welding at a comparatively high deposition rate for a remaining portion of said repaired portion.

4. A method of repairing a turbine rotor as claimed in claim 2,
wherein said repaired portion is formed by first performing build-up welding at a comparatively low deposition rate from a first layer of said repaired portion up to a predetermined height and then performing build-up welding at a comparatively high deposition rate for a remaining portion of said repaired portion.

5. A method of repairing a turbine rotor as claimed in claim 1,
wherein a groove is formed in said repaired portion in order to restore a rotor blade groove.

6. A method of repairing a turbine rotor as claimed in claim 2,
wherein a groove is formed in said repaired portion in order to restore a rotor blade groove.

7. A method of repairing a turbine rotor as claimed in claim 3,
wherein a groove is formed in said repaired portion in order to restore a rotor blade groove.

8. A method of repairing a turbine rotor as claimed in claim 4,
wherein a groove is formed in said repaired portion in order to restore a rotor blade groove.

9. A method of repairing a turbine rotor as claimed in claim 1,
wherein said thin-layer build-up welding at a high deposition rate is achieved by a welding method with a deposition rate higher than TIG welding.
